(19) United States
(12) Patent Application Publication
(10) Pub. No.: US 2005/0095907 A1
(43) Pub. Date: May 5, 2005

(54) Receptacle for booster cable with clamp

(76) Inventors: Wing Hok Ng, Hong Kong (HK); Chi Choeng Lo, Guanlan (CN)

Correspondence Address: RABIN & Berdo, PC, 1101 14TH STREET, NW, SUITE 500, WASHINGTON, DC, 20005, US

(21) Appl. No.: 10/829,470

(22) Filed: Apr. 22, 2004

(30) Foreign Application Priority Data
Apr. 29, 2003 (CN) 03225587.X

(51) Int. Cl. H01R 13/60

(52) U.S. Cl. 439/528

(57) ABSTRACT

The present invention relates to a receptacle for vehicle booster cable with clamp, which comprises a body for receiving a clamp. The body has an open entrance end and a closed stopping end. A pair of protrusions is radially and inwardly protruded from the opposite sides of the open entrance end. Their shape needs to match with the recesses provided on the outer side surface of handgrip portion of the clamp so as to maintain the clamp in the body in a snap fasten manner when the clamp is inserted into the receptacle while the clamp is not in use.

### BACKGROUND OF THE INVENTION

1. Field of the Invention

The present invention relates to means for preventing access to live contacts, and particularly to a receptacle for vehicle booster cable with clamp.

2. Description of the Related Art

Generally speaking, vehicle booster cable clamp with spring actuated metallic clamping jaws is enclosed by sheath made of insulative material such as plastic. The clamp is fixed on one end of the booster cable, the collet of which clips on the terminal of car battery. The other end of the booster cable is coupled to a power source such as spare battery case of vehicle. If one end of the booster cable connects with power supply while the other end is allowed to lay loosely about, there is a potential hazard. Moreover, there is also need for a safe, fastness and reliable receptacle for the clamps and cable while not in use.

In order to fulfill the needs mentioned above, U.S. Pat. No. 5,166,478 to Kerry Sprouse discloses an insulative protective sheath for live end of a vehicle booster cable, therein the sheath comprises a receptacle with interior and exterior portions constructed of insulative material, and includes a permanent closed stopping end and a open entrance end. In the receptacle, a vertical retainer mounting plate is provided at the closed stopping end. The open entrance end is accessible for insertion of a clamp into the interior portion. After inserting thereinto, the collet is kept in the receptacle by means of the clamp to clip the retainer mounting plate, while another clamp connects the outer fixation component via the exterior of the sheath. Such retained clamp can be easily loosed from the receptacle under vibration or outer force and forms a short circuit by contacting with another externally placed clamp.

U.S. Pat. No. 5,183,407 to Karl Srol discloses another safety cap of vehicle booster cable. However, such safety cap is similar to Sprouse's protective receptacle. So that, Srol's safety cap also have aforesaid deficiencies.

The present invention provides a novel receptacle for booster cable with clamp, which is safe and portable.

### SUMMARY OF THE INVENTION

Accordingly, it is an object of present invention to provide a receptacle for vehicle booster cable with clamp, which comprises a body for receiving a clamp, while the body has an open entrance end and a closed stopping end opposite to the open entrance end. The interior shape of which matches with the exterior shape of the clamp sheath, a radially and inwardly protruded protrusion is provided on opposite sides of the upper portion of the open entrance end respectively, and said protrusions match with the recesses formed on the outer side surface of handgrip portion of the clamp.

The shape of the recesses of the outer side surface of the handgrip portion of the clamp substantially matches with the impression of finger.

At least one side of another opposite sides of the upper portion of open entrance end of the receptacle provides a recess portion, which matches with the shape of at least one of the protrusions of the pivot of the cable clamp.

Alternately, another opposite sides of the upper portion of open entrance end of the receptacle provide recess portions respectively, which match with the shape of two protrusions of the pivot of the cable clamp.

The recess portion is substantially “U” shape with the protrusions of the pivot of cable clamp appearing as disc shape.

The body and the handgrip portion of the clamp are formed by plastic material.

### BRIEF DESCRIPTION OF THE DRAWINGS

The invention will be described in further detail below with reference to the annexed drawings, in which:

FIG. 1 is a perspective view of the present invention.

FIG. 2 is a perspective view of cable clamp of FIG. 1.

FIG. 3 is a front sectional view of present invention of FIG. 1.

FIG. 4 is a side sectional view of present invention of FIG. 1.

### DETAILED DESCRIPTION OF THE INVENTION

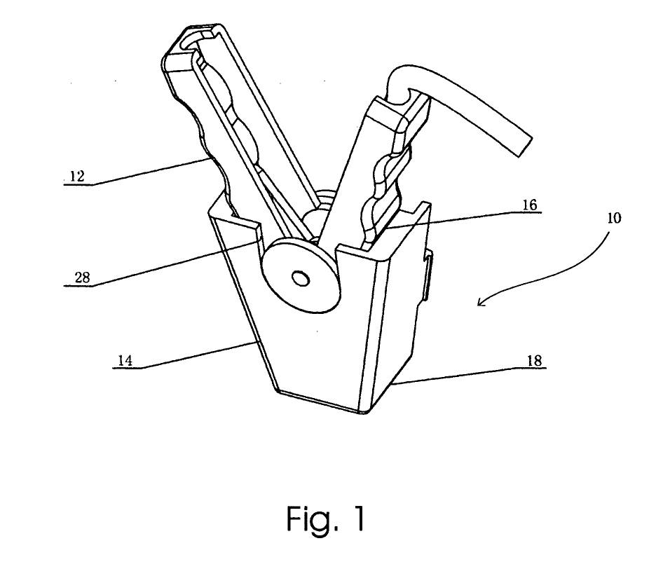

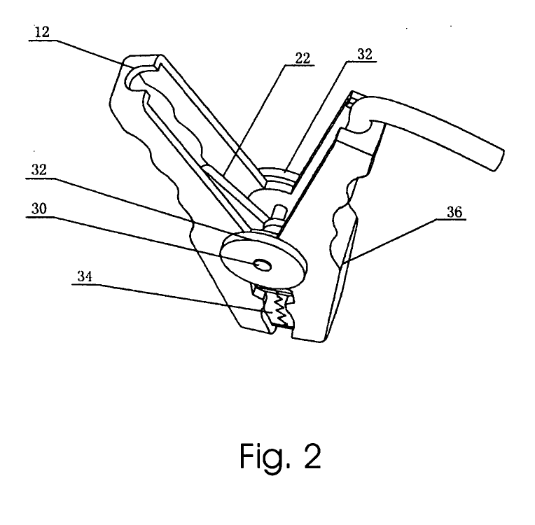

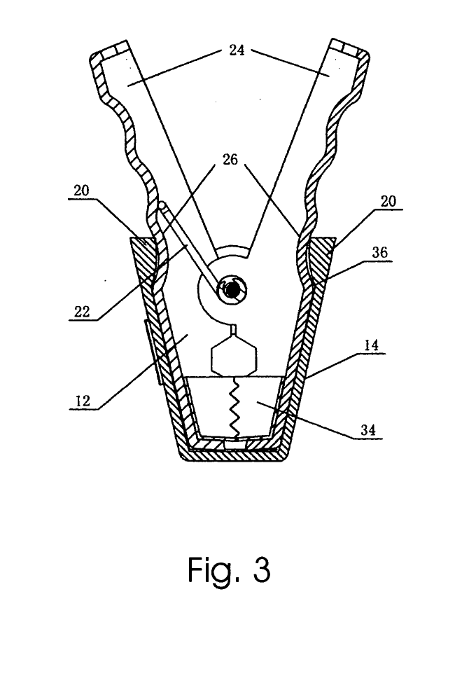

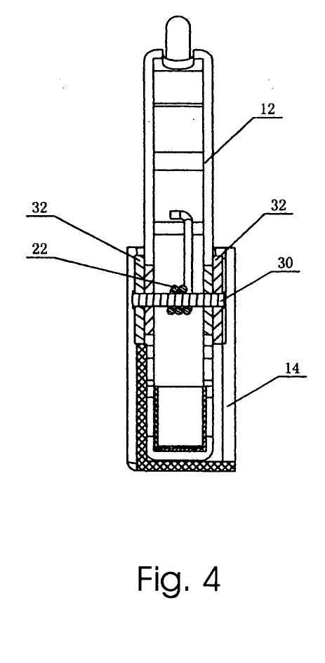

As shown in FIG. 1 to FIG. 4, a receptacle 10 for vehicle booster cable clamp according to the present invention includes a body 14 constructed of insulative material for receiving a vehicle booster cable clamp 12, and having a open entrance end 16 for insertion of the clamp and a closed stopping end 18.

The body 14 is substantially in a trapezoidal shape, which tapers from the open entrance end to the closed stopping end, the interior shape of which matches with the exterior shape of the clamp sheath. A radially and inwardly protruded protrusion 20 is provided on opposite sides of the upper portion of the open entrance end 16, and the outer side surface of the protrusion 20 is preferably in an arc shape.

Generally, the collet 34 of the clamp 12 of the booster cable terminal is an alligator clamp, the fixed end of which is enclosed within a sheath being integrally formed with the clamp handgrip portion 24, and the collet 34 is closed by means of a bias spring 22 provided on the pivot axis 30 of the handgrip.

In this embodiment, the clamp 12 is designed in such a shape: the outer side surface of clamp's handgrip portion 24 has a recessed configuration which substantially conform to the finger's impression and both handgrips are preferably symmetric with each other; when the collet portion 34 of the clamp 12 is entirely inserted into the body 14, the protrusions 20 of opposite sides of the open entrance end 16 of the body just cooperate with recesses 26 of handgrip portion 24 of the clamp, while the end point (starting point) of the lower end of said recess is just sustained at the bottom of protrusions 20. Such a type of design results in that on one hand the clamp is easily kept in the body, and on the other hand, the handgrip of clamp is easy to be hand-held.

In order for the clamp firmly to retain in the body without loose, recess portions 28 may provide on another opposite sides of the open entrance end 16 of the body respectively. In this embodiment, the recess portions 28 appear as “U” shape. Both ends of the axis 30 of the clamp provide a protruded component 32 respectively, such as but not limited to a disc component. Both protruded components 32 are respectively in both sides of the handgrip portions. Each of the protruded components 32 is tight fit with the corresponding one recess portion 28; thereby, after the collet 34 of the clamp 12 is entirely inserted into the body 14, the protruded portions 32 are just locked in the corresponding recess portions 28, so as to make the clamp 12 further be fixed in the body 14. Of course, the recess portions and the protruded portions can also use other shapes for tight fitting with each other.

In another embodiment, a recess portion can also provide on only one side of the open entrance end 16 of the body, while the corresponding end of the axis of the clamp provides a protruded portion that tightly fitted with the recess portion.

In aforesaid embodiments, the sheath of the clamp and the handgrip portion and the body are made of insulative material.

Due to this type of design having the protrusions 20 providing at the open entrance end of the body and the shape of the clamp tightly fitted with the body, the clamp and the body can be functioned as snap fastener. So that, when one of the clamps of the booster cable is inserting into or pulling out of the body, a gentle sound of “click” can be heard.

Generally speaking, both clamps of the booster cable match with each body respectively, while the body can be secured with the associated devices such as a spare battery charger on the same side or opposite sides. General methods can be used for securing the body such as snap hanging, affixation and so on.

Preferred embodiments of the present invention have been described with reference to the annexed drawings and using specific terms, but these are only for general description, and not limitation. It should be understood, however, that various modifications would be apparent to those skilled in the art, without departing from the scope of the invention as defined in the appended claims. Hence, it should be recognized that such some variations or modifications come within the scope of the invention.

1. A receptacle for vehicle booster cable with clamp, which comprises a body with an open entrance end and a closed stopping end opposite to the said open entrance end, the interior shape of which matches with the exterior shape of the clamp sheath, a radially and inwardly protruded protrusion is provided on opposite sides of the upper portion of said open entrance end respectively, and said protrusions match with the recesses formed on the outer side surface of handgrip portion of the clamp.

2. The receptacle of claim 1, wherein said recess shape of outer side surface of the handgrip portion of the cable clamp substantially appears as the shape of finger's impression.

3. The receptacle of claim 1, wherein at least one side of another opposite sides of the upper open entrance end of the body provides a recess portion, which matches with the shape of at least one protruded components of the clamp pivot.

4. The receptacle of claim 1, wherein two sides of another opposite sides of the upper open entrance end of the body provide a recess portion respectively, which match with both protruded components of the clamp pivot.

5. The receptacle of claim 3, wherein said the recess portion is substantially in a “U” form, while the protruded portion of the clamp pivot is in a disc form.

6. The receptacle of claim 1, wherein said body and the handgrip of the clamp are made of plastic material.

7. The receptacle of claim 4, wherein said the recess portion is substantially in a “U” form, while the protruded portion of the clamp pivot is in a disc form.
